(19) United States
(12) Patent Application Publication
(10) Pub. No.: US 2022/0050884 A1
(43) Pub. Date: Feb. 17, 2022

(54) UTILIZING MACHINE LEARNING MODELS TO AUTOMATICALLY GENERATE A SUMMARY OR VISUALIZATION OF DATA

(71) Applicant: Accenture Global Services Limited, Dublin (IE)

(72) Inventors: Birendra Kumar SAHU, Bangalore (IN); Sandip SINHA, Bangalore (IN); Surendra ABISHEK KUMAR, New Delhi (IN)

(21) Appl. No.: 16/990,625

(22) Filed: Aug. 11, 2020

(51) Int. Cl. G06F 16/9538; G06N 20/00; G06N 5/02; G06N 5/04; G06Q 30/02

(52) U.S. Cl. CPC G06F 16/9538; G06N 20/00; G06Q 30/0201; G06N 5/04; G06N 5/02

(57) ABSTRACT

In some implementations, a device may access source data associated with a web platform. The device may determine that the source data is associated with a topic. The device may extract, based on the source data being associated with the topic, web data associated with the web platform. The device may select, based on a characteristic of the web data, a model to process the web data to convert the web data to a representation associated with the web data. The model may be a summarization model that is configured to generate the representation to include a summary of text of the web data and/or a visualization model that is configured to generate the representation to include a visualization associated with the text of the web data. The device may cause the model to convert the web data to the representation.

### BACKGROUND

Scraping or harvesting refers to a process for mining data from a web page. An entity (e.g., an individual, a company, a government agency, and/or the like) may utilize the mined data to determine market trends, perform a historical analysis on the data, and/or the like.

### SUMMARY

In some implementations, a method includes accessing, by a device, source data associated with a web platform; determining, by the device, that the source data is associated with a particular topic; extracting, by the device and based on the source data being associated with the particular topic, web data associated with the web platform; selecting, by the device and based on a characteristic of the web data, a data conversion model to process the web data to convert the web data to a representation associated with the web data, wherein the data conversion model is selected from at least one of: a summarization model that is configured to generate the representation to include a summary of text of the web data, or a visualization model that is configured to generate the representation to include a visualization associated with the text of the web data; causing, by the device, the selected data conversion model to convert the web data to the representation; and performing, by the device, an action associated with the representation and the particular topic.

In some implementations, a device includes one or more memories and one or more processors, communicatively coupled to the one or more memories, to: receive first web data from a first web platform that generates information associated with an industry; determine, using a contextual analysis model, that the first web data is associated with a particular topic associated with the industry, wherein the contextual analysis model is trained to determine that information is associated with the particular topic; generate, based on determining that the first web data is associated with the particular topic, a summary of text associated with the first web data; store the summary in a knowledge base associated with the particular topic; receive second web data from a second web platform that generates market data associated with the industry; determine, using a feature analysis model, that the second web data is associated with the particular topic, wherein the feature analysis model is trained to identify that data is associated with the particular topic; generate, based on determining that the first web data is associated with the particular topic, a visualization of the second web data; store, in the knowledge base, the visualization in association with an attribute of the second web data; and configure the summary and the visualization to be provided via a display of an interactive user interface.

In some implementations, a non-transitory computer-readable medium storing instructions includes one or more instructions that, when executed by one or more processors of a device, cause the device to: receive web data from a web platform that generates information associated with a particular topic; determine that the web data includes text that is to be summarized; parse the text into sentences; filter extraneous words from the sentences to identify informative words of the sentences; determine, based on tokenizing the informative words, corresponding quantities of the informative words in the text; determine weights of the informative words based on the corresponding quantities; determine scores of the sentences based on weights of corresponding informative words that are in the sentences; select, based on the scores, a summary sentence from the sentences; generate a summary of the text that includes the summary sentence; and perform an action associated with the summary and the particular topic.

### BRIEF DESCRIPTION OF THE DRAWINGS

FIGS. 1-4 are diagrams of one or more example implementations described herein.

FIG. 5 is a diagram illustrating an example 500 of training and using a machine learning model in connection with automatically generating a summary or visualization of data.

FIG. 6 is a diagram of an example environment in which systems and/or methods described herein may be implemented.

FIG. 7 is a diagram of example components of one or more devices of FIG. 6.

FIG. 8 is a flowchart of an example process relating to utilizing machine learning models to automatically generate a summary or visualization of data.

### DETAILED DESCRIPTION

The following detailed description of example implementations refers to the accompanying drawings. The same reference numbers in different drawings may identify the same or similar elements.

An employee may be associated with an entity (e.g., a corporation, a business unit of a corporation, a government agency, and/or the like). The employee may be required to make decisions that affect the entity, stakeholders in the entity, and/or the like. The employee may make the decisions based on information that is received from multiple data platforms and that is associated with the entity, an industry associated with the entity (e.g., a financial industry, an industrial industry, a consumer goods industry, and/or the like), a particular topic, and/or the like.

However, analyzing information from multiple data platforms may include several challenges. For example, the employee may utilize a large amount of time and computing resources (e.g., processing resources, memory resources, communication resources, and/or the like) obtaining the information from the multiple platforms, converting the information into a particular format (e.g., a format associated with an application used by the user to analyze the information), analyzing the information, determining relationships between different items of information, and/or the like.

Some implementations described herein relate to a data monitoring system that analyzes data from multiple sources, determines a context and/or relationships associated with the data, and generates a representation of the data based on the determined context and/or relationships. For example, the data monitoring system may receive first web data from a first web platform that generates information associated with an industry. The data monitoring system may determine, using a contextual analysis model, that the first web data is associated with a particular topic associated with the industry. The data monitoring system may generate, based on determining that the first web data is associated with the particular topic, a summary of text associated with the first web data. The data monitoring system may store the summary in a knowledge base associated with the particular topic. The data monitoring system may receive second web data from a second web platform that generates market data associated with the industry. The data monitoring system may determine, using a feature analysis model, that the second web data is associated with the particular topic. The data monitoring system may generate, based on determining that the first web data is associated with the particular topic, a visualization of the second web data. The data monitoring system may store, in the knowledge base, the visualization in association with an attribute of the second web data. The data monitoring system may configure the summary and the visualization to be provided via a display of an interactive user interface.

In this way, the data monitoring system may conserve computing resources associated with analyzing data from multiple platforms, relative to less efficient systems. Further, the data monitoring system may enable the assessment of data across different types of data platforms, thereby improving an assessment of data from different data platforms. Additionally, the data monitoring system may increase an efficiency of analyzing data by analyzing metrics in a consolidated manner using a single system, thereby conserving computing resources that otherwise would have been utilized to analyze the data in a disparate manner using multiple systems or tools.

The data monitoring system collects information (e.g., current information, real-time information, historical information, and/or the like) that is pertinent to decision making associated with an entity, an industry associated with the entity, and/or the like. In this way, the data monitoring system facilitates decision making by an employee of the entity in a timely and cost-effective manner, maximizes returns for stakeholders in the entity, conserves computing resources for the entity that otherwise would have been wasted attempting to collect and process information from different data platforms for decision-making purposes, and/or the like.

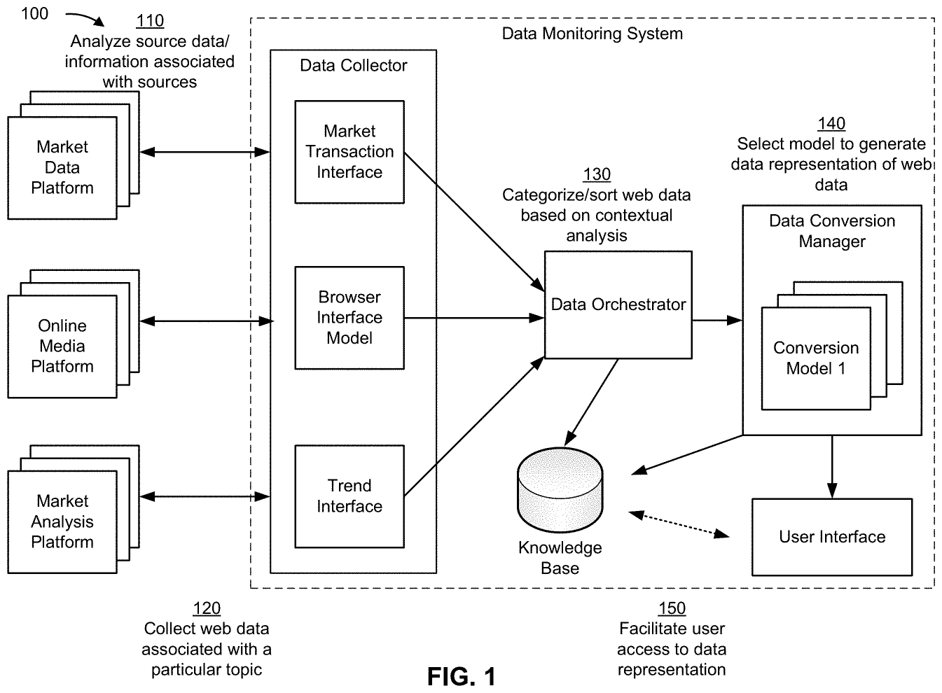

FIG. 1 is a diagram of an example implementation 100 described herein. As shown in FIG. 1, in example implementation 100 multiple data platforms may be associated with a data monitoring system. In some implementations, a data platform may be associated with an entity (e.g., a corporation, a business unit of a corporation, a department of a corporation, a government agency, a branch of a government agency, and/or the like), a competitor of the entity, a third-party data source, and/or the like.

As also shown in FIG. 1, and by reference number 110, the data monitoring system analyzes source data and/or information associated with sources. The data monitoring system may obtain source data from a source associated with a data platform. For example, the data monitoring system may obtain hypertext markup language (HTML) data, extensible markup language (XML) data, a uniform resource locator (URL), and/or the like associated with a source, such as a website, a web page, and/or the like associated with the data platform.

The source data and/or the information associated with the sources associated with a data platform may be obtained from a crawl of the Internet, from a scan of internal and/or external documents (e.g., with respect to an entity associated with the data platform), and/or the like. For example, the data monitoring system may utilize a web crawler to obtain the source data from the source. In some implementations, the data monitoring system may periodically (e.g., hourly, daily, weekly, and/or the like) utilize a web crawler to obtain source data from the source. Alternatively, and/or additionally, the data monitoring system may utilize the web crawler to obtain the source data from the source based on an occurrence of an event (e.g., based on receiving a request (e.g., from a user), based on determining that the source has been published, based on determining that the source has been modified, and/or the like). In some implementations, the source data is obtained in real time or near-real time, in that the source data is received by the data monitoring system as soon as (or nearly as soon as) the source data is generated.

The data monitoring system may analyze source data and/or information associated with a source to determine a topic associated with the source. In some implementations, the source data includes HTML data. The data monitoring system may analyze the HTML data to determine the topic associated with the source. For example, the data monitoring system may analyze the HTML data and/or XML data to identify a set of tags indicating a particular portion of the source (e.g., a title of the source, a header portion of the source, a body portion of the source, and/or the like). The data monitoring system may analyze the particular portion of the source to determine a topic associated with the source, a set of keywords associated with the topic, and/or the like.

For example, the particular portion of the source may include text corresponding to a title of the source. The data monitoring system may analyze the text to determine the topic associated with the source. In some implementations, the data monitoring system analyzes the text based on performing a natural language processing (NLP) technique.

For example, the data monitoring system may convert text to lowercase, remove punctuation, remove stop words, strip white space, perform stemming, perform lemmatization, spell out abbreviations and acronyms, and/or the like. In some implementations, the data monitoring system may remove sparse words, such as words that are uncommon (e.g., according to a domain-specific corpus, and/or the like). Preprocessing for NLP may improve accuracy of NLP and conserve computing resources that would otherwise be used to perform NLP in a less efficient fashion for an un-preprocessed data set.

In some implementations, the data monitoring system may execute a first NLP technique for analyzing unstructured text. For example, the data monitoring system may analyze unstructured text using a token-based NLP technique (e.g., a technique using regular expressions), a category-based NLP technique (e.g., a named entity recognition (NER) technique), an approximation-based NLP technique (e.g., a fuzzy text search technique), and/or the like. Additionally, or alternatively, the data monitoring system may analyze structured text using a second NLP technique (e.g., a metadata-based NLP technique and/or a similar type of technique).

In some implementations, the data monitoring system may execute a token-based NLP technique, such as a technique using regular expressions, to identify the features. For example, the data monitoring system may reference a data structure that stores regular expressions that may be used to identify a feature associated with a topic. The data monitoring system may use the regular expressions to identify the feature based on comparing the regular expressions and information included in the text.

Additionally, or alternatively, the data monitoring system may execute an approximation-based NLP technique, such as a fuzzy text search technique, to identify the features. For example, the data monitoring system may execute an approximation-based NLP technique to identify data that satisfies a threshold level of similarity with data stored in a data structure. In this case, the data monitoring system may set a threshold level of similarity (e.g., a percentage, a number of characters, etc.), and may compare information included in the text to information stored in the data structure. If the data monitoring system determines that the threshold level of similarity is satisfied, the data monitoring system may identify the information as information identifying the features.

In some implementations, the data monitoring system may use multiple NLP techniques, and may filter outputs of the multiple NLP techniques into the set of values identifying the features. For example, the data monitoring system may identify a first set of values using a first one or more NLP techniques. Additionally, the data monitoring system may identify a second set of values using a second one or more NLP techniques. In some implementations, a mixture of overlapping values and conflicting values may occur. In these implementations, the data monitoring system may address the conflicting values by filtering the first set of values and the second set of values into a third set of values that excludes duplicate values, excludes conflicting values (e.g., by selecting one value, of two conflicting values, using a rule, such a threshold), and/or the like. The data monitoring system may use the third set of values as the set of values identifying the features.

In some implementations, the data monitoring system may execute one or more of the above-mentioned NLP techniques on a particular type of portion of the source (e.g., a title, a body portion, a header portion, and/or the like), on a particular type of source data (e.g., HTML, XML, and/or the like), on source data received from a particular data platform, on a particular field or group of fields within the source data, and/or the like. Additionally, or alternatively, the data monitoring system may take an average, or a weighted average, of the outputs of the one or more NLP techniques being deployed to identify the features. As an example, the data monitoring system may assign a weight to an output associated with each additional NLP technique and may take an average or a weighted average to identify the features.

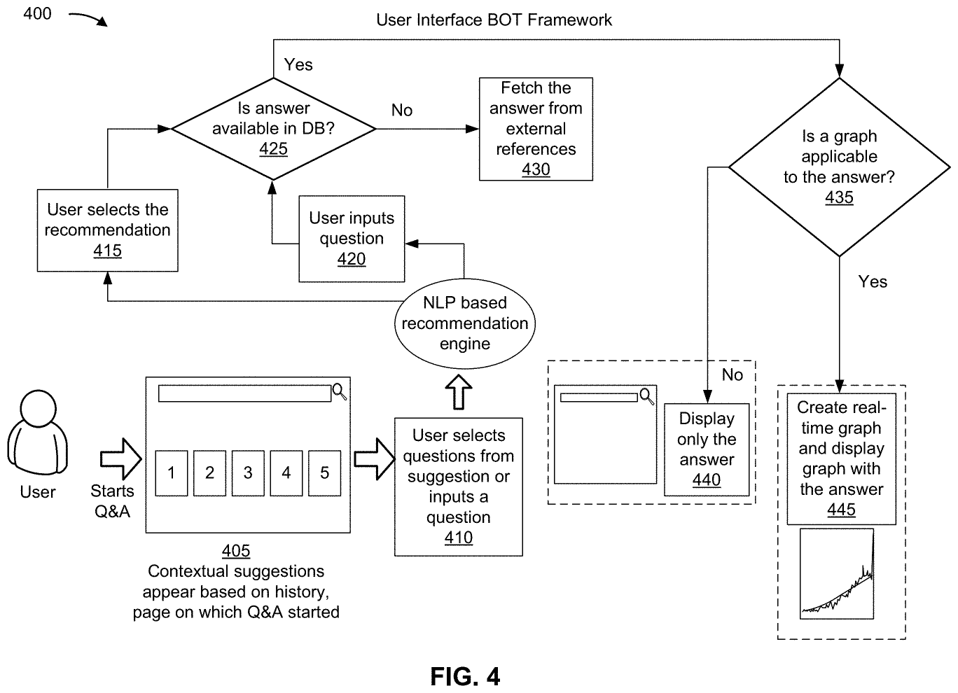

As shown by reference number 120, the data monitoring system collects web data associated with a particular topic. In some implementations, the data monitoring system collects the web data associated with the particular topic based on a user input. For example, a user may input information identifying the particular topic via a user interface associated with the data monitoring system, as described below with respect to FIG. 4.

In some implementations, the data monitoring system collects the web data based on a keyword associated with the particular topic. For example, the data monitoring system may determine a keyword associated with the particular topic based on information stored in a data structure (e.g., a database, a table, a list, and/or the like) that maps topics to keywords. The data monitoring system may identify source data associated with the particular topic based on the keyword. The data monitoring system may collect the web data from a source associated with the web data based on the source data being associated with the particular topic.

As shown in FIG. 1, the data monitoring system includes a data collector component that includes a plurality of interfaces associated with collecting the web data. An interface, of the plurality of interfaces, may be configured to collect web data from a particular data platform, web data having a particular format, and/or the like. The data monitoring system may determine a data platform from which the web data is to be obtained, a format of the web data, and/or the like, based on the source data. The data monitoring system may cause the data collector component to obtain the web data via an interface associated with the data platform, the format of the web data, and/or the like.

In some implementations, the data monitoring system obtains the web data based on the source data. For example, the source data may be a URL associated with a website. The data monitoring system may utilize the URL to obtain web data associated with the website. For example, the data monitoring system may utilize the URL to obtain HTML data, XML data, and/or the like associated with the website.

In some implementations, the web data includes the source data. For example, the source data may include HTML data and/or XML data associated with a portion of a web page (e.g., a title of the web page). The data monitoring system may obtain web data that includes HTML data and/or XML data associated with the entire web page. Alternatively, and/or additionally, the data monitoring system may obtain HTML data and/or XML data associated with a remaining portion of the web page. The data monitoring system may obtain the web data by combining the obtained HTML data and/or the XML data with the source data.

As shown by reference number 130, the data monitoring system categorizes and/or sorts web data based on a contextual analysis. The data monitoring system may perform a contextual analysis to determine a context of the web data, such as an industry associated with the web data, a location (e.g., a country, a region, and/or the like) associated with the web data, a topic or sub-topic associated with the web data, an entity associated with the web data, and/or the like.

In some implementations, the data monitoring system utilizes a contextual analysis model to perform the contextual analysis. The contextual model may be a convolutional neural network (CNN) model, a recurrent neural network model, and/or the like. The contextual analysis model may receive the web data as an input and may analyze the web data to generate an output that includes information identifying a context of the web data and a confidence score that reflects a measure of confidence that the context determined for the web data is accurate.

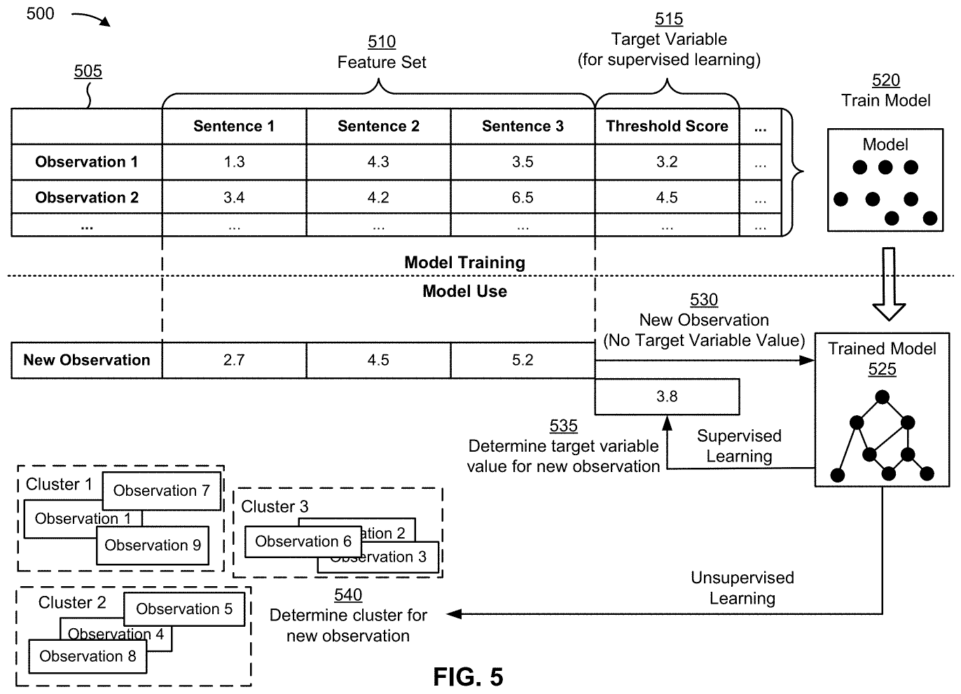

In some implementations, the data monitoring system may train the contextual analysis model to perform the contextual analysis. The contextual analysis model may be trained based on historical web data and historical data relating to a context with which the historical web data is associated. The contextual analysis model may be trained to determine, based on web data, a context with which the web data is associated and a confidence score that reflects a measure of confidence that the context is accurate for the web data. In some implementations, the data monitoring system trains the contextual analysis model in a manner similar to that described below with respect to FIG. 5. Alternatively, and/or additionally, the data monitoring system may receive a trained contextual analysis model (e.g., from another device).

In some implementations, the data monitoring system categorizes and/or sorts the web data based on the context associated with the web data. For example, the data monitoring system may categorize and/or sort the web data based on the industry associated with the web data, the location associated with the web data, the topic or sub-topic associated with the web data, the entity associated with the web data, and/or the like.

As shown in FIG. 1, the data monitoring system stores the categorized and/or sorted web data in a knowledge base. The knowledge base may be a data structure storing categorized and/or sorted web data in association with representations associated with the web data (e.g., representations generated by the data monitoring system, as described below with respect to reference numbers 140 and 150).

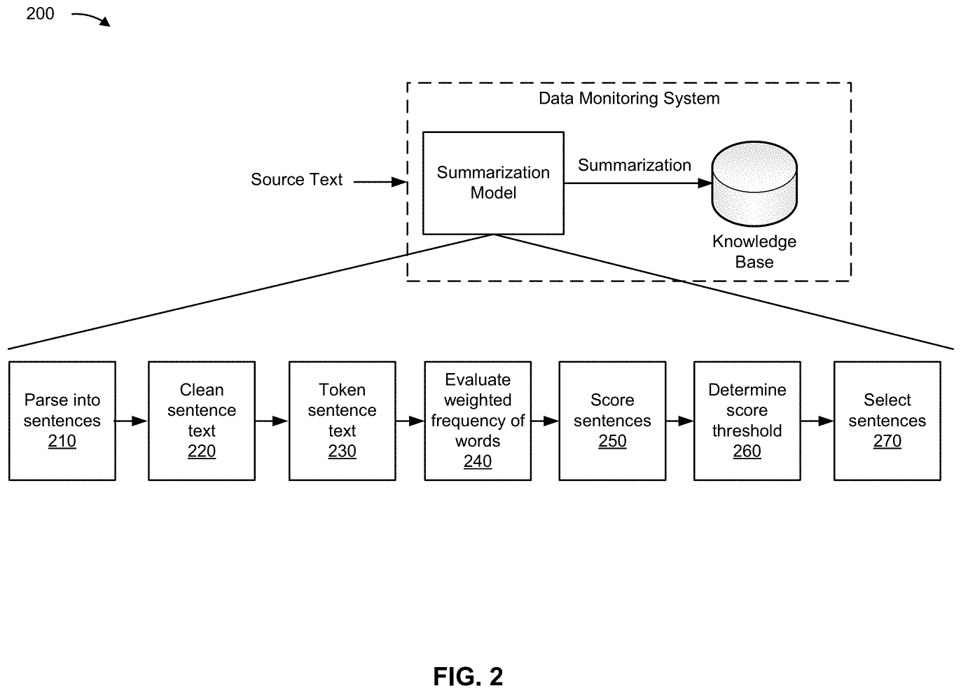

As shown by reference number 140, the data monitoring system selects a model to generate a data representation of the web data. In some implementations, the data representation includes a summarization of the web data. The summarization of the web data may include a summary of information included in the web data. For example, the summarization may include information identifying a set of key facts included in the web data, information identifying an entity associated with the web data, and/or the like. The data monitoring system may select a summarization model to generate the data representation. The summarization model may be a machine learning model that processes the web data and generates a summarization of the web data as an output, as described below with respect to FIG. 2.

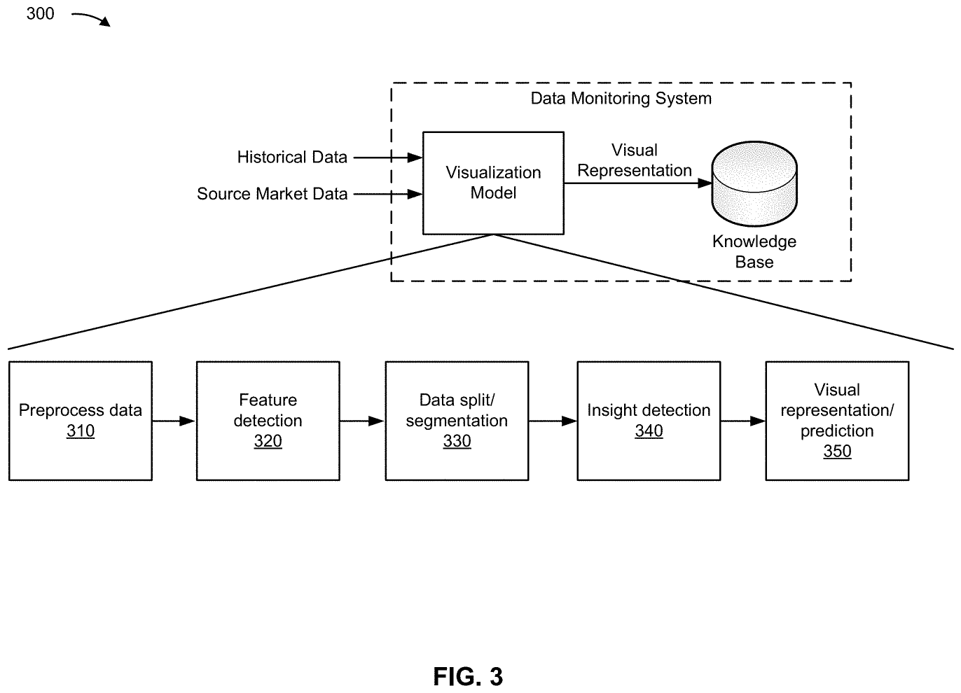

In some implementations, the data representation includes a visual representation of the web data, such as a graph, a chart, a flow diagram, and/or the like. The visual representation may include a visual depiction of a relationship associated with items of information included in the web data, a relationship associated with information included in the web data and information included in other web data, and/or the like. The data monitoring system may select a visualization model to generate the visualization. The visualization model may process the web data and may generate the visualization, as described below with respect to FIG. 3.

As shown by reference number 150, the data monitoring system facilitates user access to the data representation. The data monitoring system may facilitate user access to the data representation by providing one or more portions of the data representation to the user via a user interface associated with the data monitoring system, as described in greater detail below with respect to FIG. 4.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

FIG. 2 is a diagram of an example implementation 200 described herein. As shown in FIG. 2, the data monitoring system utilizes a summarization model to generate a summarization (e.g., a data representation) associated with the web data and stores the summarization in the knowledge base.

In some implementations, the data monitoring system trains the summarization model to generate the summarization. The summarization model may be trained based on historical web data relating to a topic and historical data relating to summarizations with which the historical web data is associated. The summarization model may be trained to determine, based on web data, a summarization of the web data and a confidence score that reflects a measure of confidence that the summarization is accurate for this web data. In some implementations, the data monitoring system trains the summarization model in a manner similar to that described below with respect to FIG. 5.

As also shown in FIG. 2, and by reference number 210, the data monitoring system parses source text into sentences. The source text may be text included in the web data. For example, the data monitoring system may process the web data to identify a set of tags indicating portions of source text. The data monitoring system may obtain the source text based on the set of tags.

As an example, the data monitoring system analyze the source data to identify a set of first level tags (e.g., a set of <html> tags). The data monitoring system may identify a first portion of data included between the set of first level tags in the HTML data. The data monitoring system may analyze the first portion of data to identify a set of second level tags (e.g., a set of <head> tags, a set of <body> tags, and/or the like). The data monitoring system may identify a second portion of data included between the set of second level tags. The data monitoring system may extract the source text from the second portion of data.

In some implementations, the data monitoring system determines that the set of second level tags are a set of lowest level tags (e.g., the second portion of data does not include a set of third level tags). The data monitoring system may extract the source text from the second portion of data based on the set of second level tags being the set of lowest level tags.

In some implementations, the data monitoring system parses the source text into sentences based on punctuation marks included in the source text. The data monitoring system may analyze the source text to determine a punctuation mark indicating an end of a sentence (e.g., a period, an exclamation point, a question mark, and/or the like). The data monitoring system may parse the source text into sentences based on the punctuation marks.

As shown by reference number 220, the data monitoring system cleans the sentence text of the sentences. The data monitoring system may clean sentence text to remove, from the sentence text, redundant and/or insignificant text that may provide little or no added value to a meaning of the sentence text. In some implementations, the data conversion model cleans the sentence text of a sentence by removing stop words from the sentence text. The stop words may comprise common words that convey little meaning relative to other words included in the sentence, such as “and”, “the”, “to”, and/or the like. Alternatively, and/or additionally, the data monitoring system cleans the sentence by removing punctuation, numbers, and/or other special characters from the sentence text.

As shown by reference number 230, the data monitoring system tokenizes the sentence text. The data monitoring system may tokenize the sentence text to identify a set of words (e.g., every word, words containing more than a threshold quantity of letters, and/or the like) included in the sentence text. The data monitoring system may identify a series of spaces in the sentence text. The data monitoring system may identify text included between a set of adjacent spaces (e.g., a first space in the series of spaces and a second space in the series of spaces). The data monitoring system may determine that the text corresponds to a word based on the text being included between the set of adjacent spaces. The data monitoring system may store a token associated with the text in a data structure based on the text corresponding to the word. The token may include the text, a root word included in the text (e.g., the root word “park” included in the text “parking”), a hash computed based on the text, and/or the like.

As shown by reference number 240, the data monitoring system evaluates the weighted frequency of words. The data monitoring system may determine a respective frequency with which each word included in the sentence text occurs in the sentence text (e.g., a quantity of times a word occurs in the sentence text). The data monitoring system may determine a word associated with a highest frequency relative to the frequencies associated with other words included in the sentence text. The data monitoring system may determine the weighted frequency for a word by dividing the frequency determined for the word by the highest frequency.

As an example, assume the sentence text includes the words “door” and “barn”. The data monitoring system may determine that the word “door” occurs twelve times in the sentence text and that the word “barn” occurs six times in the sentence text. The data monitoring system may determine that the frequency associated with the word “door” is twelve, based on the word “door” occurring twelve times in the sentence text. The data monitoring system may determine that the frequency associated with the word “barn” is six, based on the word “barn” occurring six times in the sentence text.

The data monitoring system may determine that the frequency associated with the word “door” (e.g., twelve) is the highest frequency based on the value of the frequency being greater than a value of the frequency associated with other words included in the sentence text (e.g., the frequency associated with the word “barn”). The data monitoring system may determine that the weighted frequency associated with the word “door” is equal to one, based on dividing the frequency associated with the word “door” (e.g., 12) by the highest frequency (e.g., 12). The data monitoring system may determine that the weighted frequency associated with the word “barn” is equal to 0.5, based on dividing the frequency associated with the word “barn” (e.g., 6) by the highest frequency (e.g., 12).

In some implementations, the data monitoring system determines a weighted frequency for a cleaned word associated with the sentence text. The cleaned word may correspond to a word that was removed from the sentence text based on cleaning the sentence. The data monitoring system may determine a weighted frequency equal to zero for the cleaned word based on the word being removed from the sentence text.

As shown by reference number 250, the data monitoring system scores the sentences. The data monitoring system may score a sentence, of the sentences included in the source text, based on the weighted frequencies associated with the words included in the sentence. The data monitoring system may substitute each word in the sentence with a value corresponding to the respective weighted frequency associated with that word. The data monitoring system may determine a score for the sentence based on a sum of the respective weighted frequencies associated with each word included in the sentence.

In some implementations, the data monitoring system determines the score based on a quantity of words included in the sentence. For example, the data monitoring system may determine the score based on dividing the sum of the respective frequencies associated with each word included in the sentence by a quantity of words included in the sentence. In this way, the data monitoring system may ensure that a score for a sentence having a large quantity of words relative to another sentence is not greater than a score for the other sentence based on the sentence having the larger quantity of words relative to the other sentence.

As shown by reference number 260, the data monitoring system determines a score threshold. In some implementations, the data monitoring system determines the score threshold based on an average score associated with the sentences. For example, the data monitoring system may determine a sum of the respective scores determined for the sentences and may divide the sum by a quantity of the sentences to determine the average score. The data monitoring system may determine that the score threshold corresponds to the average score. Alternatively, and/or additionally, the data monitoring system may determine the score threshold based on a mode score associated with the respective scores determined for the sentences, based on a median score associated with the respective scores determined for the sentences, based on a percentage of the respective scores determined for the sentences (e.g., top ten percent, top fifteen percent, and/or the like), and/or the like.

As shown by reference number 270, the data monitoring system selects sentences. The data monitoring system may select the sentences based on the scores and/or the score threshold. As an example, the data monitoring system may identify a group of sentences associated with a score that satisfies the score threshold. The data monitoring system may identify a set of one or more sentences, included in the group of sentences, associated with a highest set of scores relative to the scores associated with other sentences included in the group of sentences.

A quantity of sentences included in the set of sentences is determined based on a quantity of the sentences included in the source text, a quantity of sentences included in the group of sentences, and/or the like. For example, the quantity of sentences included in the set of sentences may be a percentage (e.g., one percent, five percent, ten percent, and/or the like) of the quantity of sentences included in the source text, the quantity of sentences included in the group of sentences, and/or the like.

The data monitoring system may generate the summarization associated with the web data based on the set of sentences. In some implementations, the data monitoring system generates the summarization based on an extractive-based summarization process. The data monitoring system may determine a set of words (e.g., a set of words included in the set of sentences) based on the scores and/or the weighted frequencies. The data monitoring system may generate the summarization based on combining the set of words. For example, the data monitoring system may combine the set of sentences in an order in which the set of sentences occur in the source text.

In some implementations, the data monitoring system generates the summarization based on an abstraction-based summarization process. The data monitoring system may utilize the summarization model to paraphrase and/or shorten the source text to generate the summarization.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

FIG. 3 is a diagram of an example implementation 300 described herein. As shown in FIG. 3, the data monitoring system utilizes a visualization model to generate a visual representation associated with the web data and stores the visual representation in the knowledge base.

In some implementations, the data monitoring system trains the visualization model to generate the visualization. The visualization model may be trained based on historical web data relating to a topic and historical data relating to visualizations with which the historical web data is associated. The visualization model may be trained to generate, based on web data, a visualization of the web data and a confidence score that reflects a measure of confidence that the visualization is accurate for this web data. In some implementations, the data monitoring system trains the visualization model in a manner similar to that described below with respect to FIG. 5.

As also shown in FIG. 3, and by reference number 310, the data monitoring system preprocesses data. In some implementations, the data includes the web data. Alternatively, and/or additionally, the data may include other data associated with the web data. For example, the data may include historical data associated with an industry, a topic, and/or the like associated with the web data, source market data associated with a market associated with the web data, and/or the like.

The data monitoring system may determine a set of key words associated with the web data (e.g., associated with a topic associated with the web data, words included in the web data associated with a weighted frequency that satisfies a threshold weighted frequency, and/or the like). The data monitoring system may identify source data, stored in the knowledge base, associated with the web data based on the set of keywords. The data monitoring system may determine a data platform associated with the source data. For example, the data monitoring system may determine a data platform from which the source data was obtained. The data monitoring system may mine the data platform to obtain historical data, source market data, and/or the like associated with the web data.

The data monitoring system may preprocess the data based on mining the data platform. In some implementations, preprocessing the data includes cleaning the data to remove common words. For example, the data monitoring system may clean the data in a manner similar to that described above with respect to FIG. 2.

In some implementations, preprocessing the data includes removing tags from the data. For example, the data may include HTML data, XML data, and/or the like. The data monitoring system may preprocess the data by removing the tags from the HTML data, the XML data, and/or the like.

In some implementations, preprocessing the data includes converting capitalized text to lower case text. The data monitoring system may identify a portion of the data that includes text data. The data monitoring system may convert capitalized text included in the text data to lower case text.

In some implementations, preprocessing the data includes removing duplicate and/or redundant data from the data. The data monitoring system may analyze the data to determine a first portion of the data and a second portion of the data that convey the same information. The data monitoring system may consolidate the first and second portions of the data into a single portion of data (e.g., remove one of the first portion or the second portion of the data from the data).

In some implementations, preprocessing the data includes performing a stemming operation on the data. The data monitoring system may perform a stemming operation to convert words to root forms of the words. For example, the data monitoring system may perform a stemming operation to convert the word “stopping” to the word “stop.”

In some implementations, preprocessing the data includes performing NLP on the data. The data monitoring system may perform NLP on the data in a manner similar to that described above with respect to FIG. 1.

As shown by reference number 320, the data monitoring system performs feature detection. The data monitoring system may perform feature detection based on one or more text feature detection techniques, such as a bag of words with n-grams technique, a Word2vec technique, a sentic phrase technique, a TextBlob technique, and/or the like. The data monitoring system may perform feature detection to determine a feature vector associated with the data. The feature vector may include a set of floating-point values, real-number values, and/or the like corresponding to examples, characteristics, and/or the like associated with the data.

As shown by reference number 330, the data monitoring system splits and/or segments the data. In some implementations, the data monitoring system splits and/or segments the data into sentences. For example, the data monitoring system may split and/or the segment the data into sentences in a manner similar to that described above with respect to FIG. 2.

As shown by reference number 340, the data monitoring system performs insight detection. The data monitoring system may perform insight detection to convert a sentence in a visual representation associated with the sentence. For example, the data monitoring system may perform insight detection to convert a sentence indicating a fifty percent increase in profits to a graph showing the fifty percent increase in the profits. In some implementations, the data monitoring system performs the insight detection based on the features. For example, the data monitoring system may provide a feature vector associated with the sentence to the visualization model as an input. The visualization model may process the feature vector and may generate the graph as an output.

As shown by reference number 350, the data monitoring system generates a visualization representation and/or a prediction. The data monitoring system may generate the visual representation based on performing the insight detection. For example, the data monitoring system may generate a visual representation based performing insight detection on a group of sentences included in the data.

In some implementations, the data monitoring system generates a prediction associated with the visual representation. The data monitoring system may analyze the visual representation, the data, the feature vectors, and/or the like and may generate a prediction based on the analysis. For example, the visual representation may include a graph depicting sales associated with an entity over a period of time. The data monitoring system may analyze the graph, the data, the feature vectors, and/or the like and may generate a prediction regarding future sales associated with the entity over a future period of time.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

FIG. 4 is a diagram of an example implementation 400 described herein. As shown in FIG. 4, the data monitoring system facilitates providing the data representation to a user.

As also shown in FIG. 4, the user initiates a question and answer session. In some implementations, the user initiates the question and answer session via a client device associated with the data monitoring system. For example, the user may utilize the client device to access an application associated with the data monitoring system to initiate the question and answer session.

As shown by reference number 405, contextual suggestions appear based on history and/or a page on which the question and answer session started. The contextual suggestions may include a question or query determined by the data monitoring system based on a history of question and answer sessions associated with the user, a history of question and answer sessions associated with the client device utilized by the user, a web page or a website accessed by the user prior to initiating the question and answer session, and/or the like.

As an example, the data monitoring system may determine that the user accessed a web page that includes financial information associated with an entity prior to initiating the question and answer session. The data monitoring system may determine information associated with the particular web page, such as a topic, an industry, a market, an entity, and/or the like. In some implementations, the data monitoring system determines the information associated with the particular web page based on information stored in the knowledge base. The data monitoring system may identify source data associated with the web page stored in the knowledge base. The data monitoring system may determine that the web page includes financial information associated with the entity based on a set of key words associated with the source data. The data monitoring system may determine a contextual suggestion that includes a query associated with the financial information associated with the entity.

In some implementations, the data monitoring system determines the contextual suggestion based on a summarization stored in the knowledge base. For example, the data monitoring system may determine that the source data associated with the web page is associated with a summarization stored in the knowledge base. The data monitoring system may generate the contextual suggestion based on the summarization. For example, the data monitoring system may convert a sentence included in the summarization into a question. In some implementations, the data monitoring system may associate the contextual suggestion with information indicating that the contextual suggestion is associated with the summarization (e.g., a tag, metadata, an identifier associated with the summarization, and/or the like).

As shown by reference number 410, the user selects a question from a suggestion or inputs a question. In some implementations, the user selects a question included in a contextual suggestion provided by the data monitoring system. As shown by reference number 415, the user selects the recommendation.

Alternatively, and/or additionally, the user may input a question. For example, the user may input a question into a field of a user interface associated with the data monitoring system. As shown by reference number 420, the user inputs a question. The data monitoring system may receive the question and may analyze the question to determine a topic associated with the question, an industry associated with the question, a market associated with the question, a context associated with the question, and/or the like. In some implementations, the data monitoring system may utilize an NLP technique to process the question to determine the topic, the industry, the market, and/or the like, in a manner similar to that described above. In some implementations, the data monitoring system utilizes a contextual analysis model to determine a context associated with the question in a manner similar to that described above.

As shown by reference number 425, the data monitoring system determines whether the answer is available in a database (e.g., the knowledge base). The data monitoring system may determine a set of key words associated with the question, a set of key words associated with the web page, and/or the like. In some implementations, the data monitoring system determines the set of keywords in a manner similar to that described above. The data monitoring system may utilize the set of key words to determine whether a summarization of web data associated with the question is available in the knowledge base.

In some implementations, the user selects a question included in a contextual suggestion. The data monitoring system may determine whether the contextual suggestion is associated with a summarization stored in the knowledge base. For example, the data monitoring system may determine whether the contextual suggestion is associated with information indicating that the contextual information is associated with a summarization stored in the knowledge base. The data monitoring system may determine that the answer is available in the database when the contextual suggestion is associated with the summarization stored in the knowledge base.

In some implementations, the answer is not available in the database. For example, the data monitoring system may determine that the contextual suggestion is not associated with information indicating that the contextual suggestion is associated with a summarization stored in the knowledge base. In these implementations, as shown by reference number 430, the data monitoring system fetches the answer from external references. The data monitoring system may provide the answer from the external references to the user (e.g., via the user interface).

In some implementations, the answer is available in the database. For example, the data monitoring system may determine that the contextual suggestion is associated with information indicating that the contextual suggestion is associated with a summarization stored in the knowledge base. In these implementations, as shown by reference number 435, the data monitoring system determines whether a graph (e.g., a visual representation) is applicable to the answer. The data monitoring system may analyze the answer and may determine whether the answer contains data that can be represented in a visual representation. For example, the data monitoring system may analyze the answer to determine whether the answer contains financial data, data indicating a trend, data indicating a state change, and/or the like. In some implementations, the data monitoring system determines whether a graph is applicable to the answer based on whether a visual representation associated with the answer is stored in the knowledge base.

In some implementations, a graph is not applicable to the answer. For example, the data monitoring system may determine that the answer does not include information that can be represented in a visual representation, that the answer is not associated with a visual representation stored in the knowledge base, and/or the like. In these implementations, as shown by reference number 440, the data monitoring system displays only the answer.

In some implementations, a graph is applicable to the answer. For example, the data monitoring system may determine that the answer does include information that can be represented in a visual representation, that the answer is associated with a visual representation stored in the knowledge base, and/or the like. In these implementations, as shown by reference number 445, the data monitoring system creates a real-time graph and displays the graph with the answer. Alternatively, and/or additionally, the data monitoring system obtains the visual representation associated with the answer from the knowledge base and provides the visualization for display to the user with the answer via the user interface.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

FIG. 5 is a diagram illustrating an example 500 of training and using a machine learning model in connection with utilizing machine learning models to automatically generate a summary or visualization of data. The machine learning model training and usage described herein may be performed using a machine learning system. The machine learning system may include or may be included in a computing device, a server, a cloud computing environment, and/or the like, such as the data monitoring system described in more detail elsewhere herein.

As shown by reference number 505, a machine learning model may be trained using a set of observations. The set of observations may be obtained from historical data, such as data gathered during one or more processes described herein. In some implementations, the machine learning system may receive the set of observations (e.g., as input) from the data monitoring system, as described elsewhere herein.

As shown by reference number 510, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the data monitoring system. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of Sentence 1, a second feature of Sentence 2, a third feature of Sentence 3, and so on. As shown, for a first observation, the first feature may have a value of 1.3, the second feature may have a value of 4.3, the third feature may have a value of 3.5, and so on, corresponding to sentence scores determined by the machine learning model based on processing the feature set for the first observation. These features and feature values are provided as examples, and may differ in other examples.

As shown by reference number 515, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, labels, and/or the like), may represent a variable having a Boolean value, and/or the like. A target variable may be associated with a target variable value, and a target variable value may be specific to an observation. In example 500, the target variable is Threshold Score, which has a value of 3.2 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 520, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 525 to be used to analyze new observations.

As shown by reference number 530, the machine learning system may apply the trained machine learning model 525 to a new observation, such as by receiving a new observation and inputting the new observation to the trained machine learning model 525. As shown, the new observation may include a first feature of Sentence 1, a second feature of Sentence 2, a third feature of Sentence 3, and so on, as an example. The machine learning system may apply the trained machine learning model 525 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 525 may predict a value of 3.8 for the target variable of Threshold Score for the new observation, as shown by reference number 535. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 525 may classify (e.g., cluster) the new observation in a cluster, as shown by reference number 540. The observations within a cluster may have a threshold degree of similarity. As an example, if the machine learning system classifies the new observation in a first cluster, then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

In some implementations, the recommendation and/or the automated action associated with the new observation may be based on a target variable value having a particular label (e.g., classification, categorization, and/or the like), may be based on whether a target variable value satisfies one or more threshold (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to automatically generate a summary or visualization of data. The machine learning system enables recognition and/or identification of tens, hundreds, thousands, or millions of features and/or feature values for tens, hundreds, thousands, or millions of observations, thereby increasing accuracy and consistency and reducing delay associated with automatically generating a summary or visualization of data relative to requiring computing resources to be allocated for tens, hundreds, or thousands of operators to manually generate a summary or visualization of data using the features or feature values.

As indicated above, FIG. 5 is provided as an example. Other examples may differ from what is described in connection with FIG. 5.

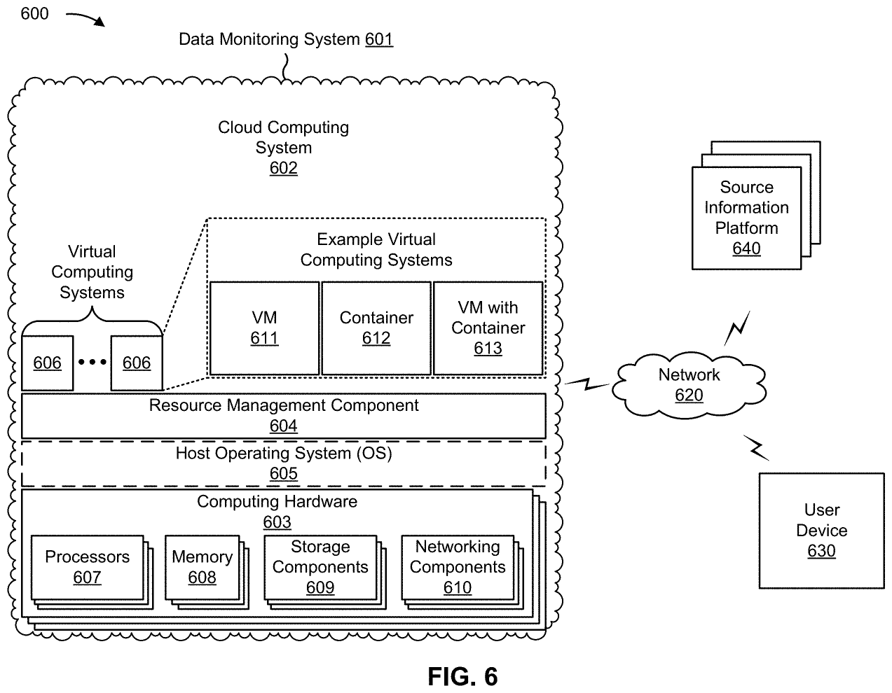

FIG. 6 is a diagram of an example environment 600 in which systems and/or methods described herein may be implemented. As shown in FIG. 6, environment 600 may include a data monitoring system 601, which may include one or more elements of and/or may execute within a cloud computing system 602. The cloud computing system 602 may include one or more elements 603-613, as described in more detail below. As further shown in FIG. 6, environment 600 may include a network 620, a user device 630, and/or a source information platform 640. Devices and/or elements of environment 600 may interconnect via wired connections and/or wireless connections.

The cloud computing system 602 includes computing hardware 603, a resource management component 604, a host operating system (OS) 605, and/or one or more virtual computing systems 606. The resource management component 604 may perform virtualization (e.g., abstraction) of computing hardware 603 to create the one or more virtual computing systems 606. Using virtualization, the resource management component 604 enables a single computing device (e.g., a computer, a server, and/or the like) to operate like multiple computing devices, such as by creating multiple isolated virtual computing systems 606 from computing hardware 603 of the single computing device. In this way, computing hardware 603 can operate more efficiently, with lower power consumption, higher reliability, higher availability, higher utilization, greater flexibility, and lower cost than using separate computing devices.

Computing hardware 603 includes hardware and corresponding resources from one or more computing devices. For example, computing hardware 603 may include hardware from a single computing device (e.g., a single server) or from multiple computing devices (e.g., multiple servers), such as multiple computing devices in one or more data centers. As shown, computing hardware 603 may include one or more processors 607, one or more memories 608, one or more storage components 609, and/or one or more networking components 610. Examples of a processor, a memory, a storage component, and a networking component (e.g., a communication component) are described elsewhere herein.

The resource management component 604 includes a virtualization application (e.g., executing on hardware, such as computing hardware 603) capable of virtualizing computing hardware 603 to start, stop, and/or manage one or more virtual computing systems 606. For example, the resource management component 604 may include a hypervisor (e.g., a bare-metal or Type 1 hypervisor, a hosted or Type 2 hypervisor, and/or the like) or a virtual machine monitor, such as when the virtual computing systems 606 are virtual machines 611. Additionally, or alternatively, the resource management component 604 may include a container manager, such as when the virtual computing systems 606 are containers 612. In some implementations, the resource management component 604 executes within and/or in coordination with a host operating system 605.

A virtual computing system 606 includes a virtual environment that enables cloud-based execution of operations and/or processes described herein using computing hardware 603. As shown, a virtual computing system 606 may include a virtual machine 611, a container 612, a hybrid environment 613 that includes a virtual machine and a container, and/or the like. A virtual computing system 606 may execute one or more applications using a file system that includes binary files, software libraries, and/or other resources required to execute applications on a guest operating system (e.g., within the virtual computing system 606) or the host operating system 605.

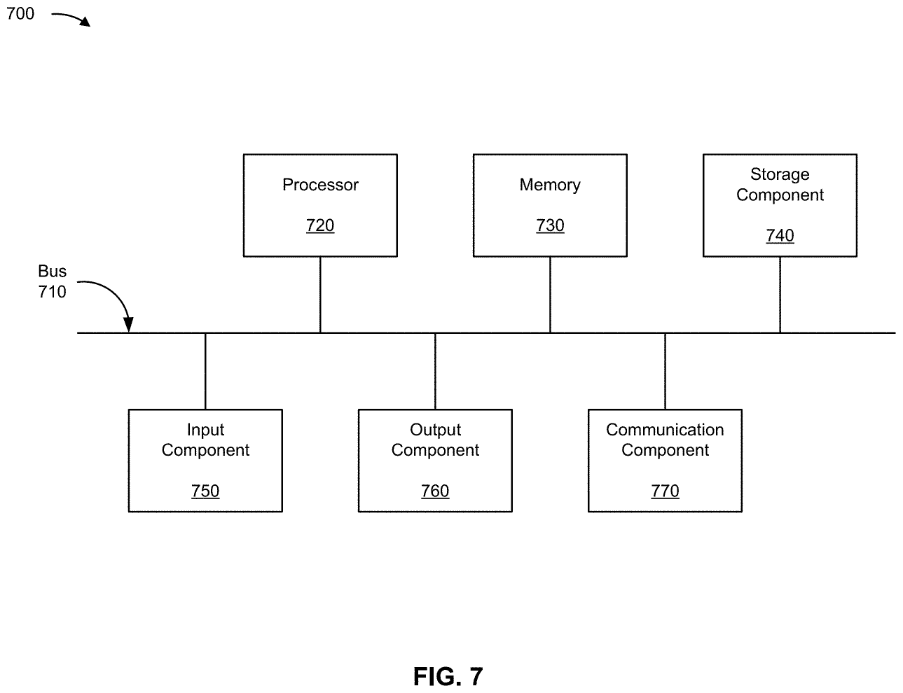

Although the data monitoring system 601 may include one or more elements 603-613 of the cloud computing system 602, may execute within the cloud computing system 602, and/or may be hosted within the cloud computing system 602, in some implementations, the data monitoring system 601 may not be cloud-based (e.g., may be implemented outside of a cloud computing system) or may be partially cloud-based. For example, the data monitoring system 601 may include one or more devices that are not part of the cloud computing system 602, such as device 700 of FIG. 7, which may include a standalone server or another type of computing device. The data monitoring system 601 may perform one or more operations and/or processes described in more detail elsewhere herein.

Network 620 includes one or more wired and/or wireless networks. For example, network 620 may include a cellular network, a public land mobile network (PLMN), a local area network (LAN), a wide area network (WAN), a private network, the Internet, and/or the like, and/or a combination of these or other types of networks. The network 620 enables communication among the devices of environment 600.

User device 630 includes one or more devices capable of receiving, generating, storing, processing, and/or providing information associated with automatically generating a summary or visualization of data, as described elsewhere herein. User device 630 may include a communication device and/or a computing device. For example, user device 630 may include a wireless communication device, a user equipment (UE), a mobile phone (e.g., a smart phone or a cell phone, among other examples), a laptop computer, a tablet computer, a handheld computer, a desktop computer, a gaming device, a wearable communication device (e.g., a smart wristwatch or a pair of smart eyeglasses, among other examples), an Internet of Things (IoT) device, or a similar type of device. User device 630 may communicate with one or more other devices of environment 600, as described elsewhere herein.

Source information platform 640 includes one or more devices capable of receiving, generating, storing, processing, and/or providing information associated with automatically generating a summary or visualization of data, as described elsewhere herein. Source information platform 640 may include a communication device and/or a computing device. For example, source information platform 640 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. Source information platform 640 may communicate with one or more other devices of environment 600, as described elsewhere herein.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of environment 600 may perform one or more functions described as being performed by another set of devices of environment 600.

FIG. 7 is a diagram of example components of a device 700, which may correspond to data monitoring system 601, user device 630, and/or source information platform 640. In some implementations, data monitoring system 601, user device 630, and/or source information platform 640 may include one or more devices 700 and/or one or more components of device 700. As shown in FIG. 7, device 700 may include a bus 710, a processor 720, a memory 730, a storage component 740, an input component 750, an output component 760, and a communication component 770.

Bus 710 includes a component that enables wired and/or wireless communication among the components of device 700. Processor 720 includes a central processing unit, a graphics processing unit, a microprocessor, a controller, a microcontroller, a digital signal processor, a field-programmable gate array, an application-specific integrated circuit, and/or another type of processing component. Processor 720 is implemented in hardware, firmware, or a combination of hardware and software. In some implementations, processor 720 includes one or more processors capable of being programmed to perform a function. Memory 730 includes a random access memory, a read only memory, and/or another type of memory (e.g., a flash memory, a magnetic memory, and/or an optical memory).

Storage component 740 stores information and/or software related to the operation of device 700. For example, storage component 740 may include a hard disk drive, a magnetic disk drive, an optical disk drive, a solid state disk drive, a compact disc, a digital versatile disc, and/or another type of non-transitory computer-readable medium. Input component 750 enables device 700 to receive input, such as user input and/or sensed inputs. For example, input component 750 may include a touch screen, a keyboard, a keypad, a mouse, a button, a microphone, a switch, a sensor, a global positioning system component, an accelerometer, a gyroscope, an actuator, and/or the like. Output component 760 enables device 700 to provide output, such as via a display, a speaker, and/or one or more light-emitting diodes. Communication component 770 enables device 700 to communicate with other devices, such as via a wired connection and/or a wireless connection. For example, communication component 770 may include a receiver, a transmitter, a transceiver, a modem, a network interface card, an antenna, and/or the like.

Device 700 may perform one or more processes described herein. For example, a non-transitory computer-readable medium (e.g., memory 730 and/or storage component 740) may store a set of instructions (e.g., one or more instructions, code, software code, program code, and/or the like) for execution by processor 720. Processor 720 may execute the set of instructions to perform one or more processes described herein. In some implementations, execution of the set of instructions, by one or more processors 720, causes the one or more processors 720 and/or the device 700 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 7 are provided as an example. Device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

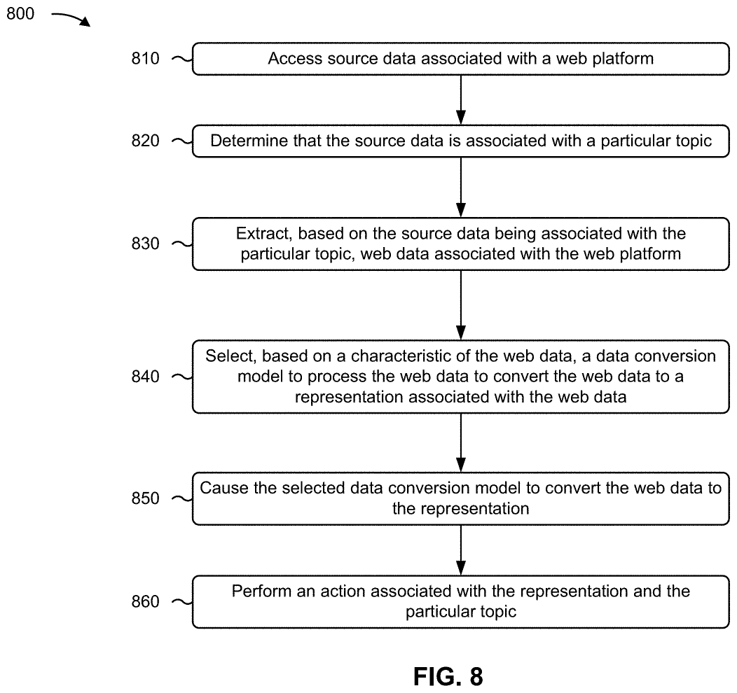

FIG. 8 is a flowchart of an example process 800 associated with utilizing machine learning models to automatically generate a summary or visualization of data. In some implementations, one or more process blocks of FIG. 8 may be performed by a device (e.g., data monitoring system 601). In some implementations, one or more process blocks of FIG. 8 may be performed by another device or a group of devices separate from or including the device, such as a user device (e.g., user device 630) and/or a source information platform (e.g., source information platform 640. Additionally, or alternatively, one or more process blocks of FIG. 8 may be performed by one or more components of device 700, such as processor 720, memory 730, storage component 740, input component 750, output component 760, and/or communication component 770.

As shown in FIG. 8, process 800 may include accessing source data associated with a web platform (block 810). For example, the device may access source data associated with a web platform, as described above. In some implementations, the web platform comprises an online media platform and the source data comprises textual information associated with an industry. Alternatively, and/or additionally, the web platform may comprise a market data platform and the source data may comprise value data associated with a market of the industry.

Prior to accessing the source data, the device may receive a list of web platforms associated with generating information associated with the particular topic. The device may access the source data based on the web platform being on the list of web platforms.

As further shown in FIG. 8, process 800 may include determining that the source data is associated with a particular topic (block 820). For example, the device may determine that the source data is associated with a particular topic, as described above. When determining that the source data is associated with the particular topic, the device may process, using a machine learning model, the source data to determine that the source data is associated with the particular topic. The machine learning model may be trained to detect that the source data is associated with the particular topic based on a plurality of key words associated with the particular topic.

As further shown in FIG. 8, process 800 may include extracting, based on the source data being associated with the particular topic, web data associated with the web platform (block 830). For example, the device may extract, based on the source data being associated with the particular topic, web data associated with the web platform, as described above.

As further shown in FIG. 8, process 800 may include selecting, based on a characteristic of the web data, a data conversion model to process the web data to convert the web data to a representation associated with the web data (block 840). For example, the device may select, based on a characteristic of the web data, a data conversion model to process the web data to convert the web data to a representation associated with the web data, as described above. In some implementations, the data conversion model is selected from at least one of: a summarization model that is configured to generate the representation to include a summary of text of the web data, or a visualization model that is configured to generate the representation to include a visualization associated with the text of the web data. The characteristic of the web data comprises at least one of a context of the web data, a type of the web platform that generated the web data, a format of the web data, or a location of the web data.

When generating the summary, the device may parse the text into sentences; remove extraneous words from the sentences to identify informative words of the sentences; determine quantities of the informative words in the text; determine weights of the informative words based on the quantities; determine scores of the sentences based on which of the informative words are in the sentences and weights of corresponding informative words that are in the sentences; and select, from the sentences, a summary sentence that is to be included in the summary based on the scores.

Alternatively, and/or additionally, when generating the summary, the device may determine that the web data includes text that is to be summarized; parse the text into sentences; filter extraneous words from the sentences to identify informative words of the sentences; determine, based on tokenizing the informative words, corresponding quantities of the informative words in the text; determine weights of the informative words based on the corresponding quantities; determine scores of the sentences based on weights of corresponding informative words that are in the sentences; select, based on the scores, a summary sentence from the sentences; and generate a summary of the text that includes the summary sentence. The summary sentence may be selected for a paragraph summary of the text paragraph and the paragraph summary may be one of a plurality of paragraph summaries of the summary.

In some implementations, the device may store, in a knowledge base associated with the particular topic, the summary as a data representation of the web data; configure the summary for display via an interactive user interface based on an informative attribute of the text; generate, for the interactive user interface, an input suggestion associated with the informative attribute to facilitate access to the summary; or provide, to a user device, a notification that the summary is accessible via the interactive user interface.

When determining the scores of the sentences, the device may identify a set of the informative words that are in the sentence; assign individual weights of the set of the informative words to the sentence; and determine the score of the sentence based on the individual weights. The score of the sentence may indicate a relevance of the sentence to the text relative to other sentences of the text.

To select the summary sentence, the device may determine, based on the scores, a score threshold; determine that a score associated with the summary sentence satisfies the score threshold; and select the summary sentence based on the score satisfying the score threshold. The score threshold may correspond to at least one of an average of the scores; a range of scores; or a percentage of a most relevant score of the scores.

When generating the visualization, the device may analyze, using the feature analysis model, the second web data to identify feature data of the second web data; process, using a data split and segmentation technique, the feature data to determine a feature relationship associated with elements of the feature data; and configure the visualization according to the feature relationship and the elements.

In some implementations, the device may determine, based on an object detection analysis, an informative attribute of the source data. The device may map the summary to the informative attribute in a knowledge base. The device may map the summary to the informative attribute to cause an interactive user interface to suggest or display the summary based on a first received input.

Alternatively, and/or additionally, the device may determine an attribute of the source data and may map the visualization to the data attribute in the knowledge base. The device may map the visualization to the data attribute to cause the interactive user interface to suggest or display the visualization based on a second received input.

As further shown in FIG. 8, process 800 may include causing the selected data conversion model to convert the web data to the representation (block 850). For example, the device may cause the selected data conversion model to convert the web data to the representation, as described above.

As further shown in FIG. 8, process 800 may include performing an action associated with the representation and the particular topic (block 860). For example, the device may perform an action associated with the representation and the particular topic, as described above.

In some implementations, the device may determine, based on a contextual analysis of the web data, a context of the representation. The device may store, in association with the context, the representation in a knowledge base associated with an interactive user interface. The device may receive an input in a field of the interactive user interface. The device may determine that the input is likely associated with the representation. The device may perform the action, based on determining that the input is likely associated with the representation, by suggesting presentation of the representation via the interactive user interface.

When performing the action, the device may determine, based on a contextual analysis of the web data, a context of the representation. The device may configure, for an interactive user interface, an input suggestion associated with the representation. The input suggestion may identify the context. The device may cause the interactive user interface to present the input suggestion via a display of the interactive user interface to indicate an availability of the representation.

Alternatively, and/or additionally, when performing the action, the device may configure the representation for display via a user interface; provide, to a user device, the representation via an interactive user interface; provide, to the user device, a notification associated with a characteristic of the web data to permit the user device to access the representation via the interactive user interface; and/or generate a report associated with the representation based on an input that identifies an attribute of the web data and that is received via the interactive user interface.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, etc., depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
accessing, by a device, source data associated with a web platform;
determining, by the device, that the source data is associated with a particular topic;
extracting, by the device and based on the source data being associated with the particular topic, web data associated with the web platform;
selecting, by the device and based on a characteristic of the web data, a data conversion model to process the web data to convert the web data to a representation associated with the web data,
wherein the data conversion model is selected from at least one of:
a summarization model that is configured to generate the representation to include a summary of text of the web data, or
a visualization model that is configured to generate the representation to include a visualization associated with the text of the web data;
causing, by the device, the selected data conversion model to convert the web data to the representation; and
performing, by the device, an action associated with the representation and the particular topic.

2. The method of claim 1, further comprising:
prior to accessing the source data, receiving a list of web platforms associated with generating information associated with the particular topic,
wherein the source data is accessed based on the web platform being on the list of web platforms.

3. The method of claim 1, wherein determining that the source data is associated with the particular topic comprises:
processing, using a machine learning model, the source data to determine that the source data is associated with the particular topic,
wherein the machine learning model is trained to detect that the source data is associated with the particular topic based on a plurality of key words associated with the particular topic.

4. The method of claim 1, wherein the characteristic of the web data comprises at least one of:
a context of the web data;
a type of the web platform that generated the web data;
a format of the web data; or
a location of the web data.

5. The method of claim 1, further comprising, prior to performing the action:
determining, based on a contextual analysis of the web data, a context of the representation;
storing, in association with the context, the representation in a knowledge base associated with an interactive user interface;
receiving an input in a field of the interactive user interface; and
determining that the input is likely associated with the representation,
wherein the action is performed, based on determining that the input is likely associated with the representation, by suggesting presentation of the representation via the interactive user interface.

6. The method of claim 1, wherein performing the action comprises:
determining, based on a contextual analysis of the web data, a context of the representation;
configuring, for an interactive user interface, an input suggestion associated with the representation,
wherein the input suggestion identifies the context; and
causing the interactive user interface to present the input suggestion via a display of the interactive user interface to indicate an availability of the representation.

7. The method of claim 1, wherein performing the action comprises at least one of:
configuring the representation for display via a user interface;
providing, to a user device, the representation via an interactive user interface;
providing, to the user device, a notification associated with a characteristic of the web data to permit the user device to access the representation via the interactive user interface; or
generating a report associated with the representation based on an input that identifies an attribute of the web data,
wherein the input is received via the interactive user interface.

8. A device, comprising:
one or more memories; and
one or more processors, communicatively coupled to the one or more memories, to:
receive first web data from a first web platform that generates information associated with an industry;
determine, using a contextual analysis model, that the first web data is associated with a particular topic associated with the industry,
wherein the contextual analysis model is trained to determine that information is associated with the particular topic;
generate, based on determining that the first web data is associated with the particular topic, a summary of text associated with the first web data;
store the summary in a knowledge base associated with the particular topic;
receive second web data from a second web platform that generates market data associated with the industry;
determine, using a feature analysis model, that the second web data is associated with the particular topic,
wherein the feature analysis model is trained to identify that data is associated with the particular topic;
generate, based on determining that the first web data is associated with the particular topic, a visualization of the second web data;
store, in the knowledge base, the visualization in association with an attribute of the second web data; and
configure the summary and the visualization to be provided via a display of an interactive user interface.

9. The device of claim 8, wherein the first web platform comprises an online media platform and the information comprises textual information associated with the industry, and
wherein the second web platform comprises a market data platform and the market data comprises value data associated with a market of the industry.

10. The device of claim 8, wherein the one or more processors are configured to, when storing the summary:
determine, based on an object detection analysis, an informative attribute of the first web data; and
map the summary to the informative attribute in the knowledge base.

11. The device of claim 8, wherein the one or more processors are configured to, when storing the visualization:
determine a data attribute of the second web data; and
map the visualization to the data attribute in the knowledge base.

12. The device of claim 8, wherein the one or more processors are configured to, when generating the summary:
parse the text into sentences;
remove extraneous words from the sentences to identify informative words of the sentences;
determine quantities of the informative words in the text;
determine weights of the informative words based on the quantities;
determine scores of the sentences based on which of the informative words are in the sentences and weights of corresponding informative words that are in the sentences; and
select, from the sentences, a summary sentence that is to be included in the summary based on the scores.

13. The device of claim 8, wherein the one or more processors are configured to, when generating the visualization:
analyze, using the feature analysis model, the second web data to identify feature data of the second web data;
process, using a data split and segmentation technique, the feature data to determine a feature relationship associated with elements of the feature data; and
configure the visualization according to the feature relationship and the elements.

14. The device of claim 8, wherein the one or more processors, when configuring the summary and the visualization, are to at least one of:
map the summary to an informative attribute of the first web data to cause the interactive user interface to suggest or display the summary based on a first received input; or
map the visualization to a data attribute of the second web data to cause the interactive user interface to suggest or display the visualization based on a second received input.

15. A non-transitory computer-readable medium storing instructions, the instructions comprising:
one or more instructions that, when executed by one or more processors of a device, cause the device to:
receive web data from a web platform that generates information associated with a particular topic;
determine that the web data includes text that is to be summarized;
parse the text into sentences;
filter extraneous words from the sentences to identify informative words of the sentences;
determine, based on tokenizing the informative words, corresponding quantities of the informative words in the text;
determine weights of the informative words based on the corresponding quantities;
determine scores of the sentences based on weights of corresponding informative words that are in the sentences;
select, based on the scores, a summary sentence from the sentences;
generate a summary of the text that includes the summary sentence; and
perform an action associated with the summary and the particular topic.

16. The non-transitory computer-readable medium of claim 15, wherein the text is associated with a text paragraph of a plurality of text paragraphs of the web data,
wherein the summary sentence is selected for a paragraph summary of the text paragraph, and
wherein the paragraph summary is one of a plurality of paragraph summaries of the summary.

17. The non-transitory computer-readable medium of claim 15, wherein the one or more instructions, that cause the device to determine the scores, cause the device to:
for a sentence, of the sentences:
identify a set of the informative words that are in the sentence;
assign individual weights of the set of the informative words to the sentence; and
determine the score of the sentence based on the individual weights,
wherein the score of the sentence indicates a relevance of the sentence to the text relative to other sentences of the text.

18. The non-transitory computer-readable medium of claim 15, wherein the one or more instructions, that cause the device to select the summary sentence, cause the device to:
determine, based on the scores, a score threshold;
determine that a score associated with the summary sentence satisfies the score threshold; and
select the summary sentence based on the score satisfying the score threshold.

19. The non-transitory computer-readable medium of claim 18, wherein the score threshold corresponds to at least one of:
an average of the scores;
a range of the scores; or
a percentage of a most relevant score of the scores.

20. The non-transitory computer-readable medium of claim 15, wherein the one or more instructions, that cause the device to generate the summary, cause the device to:
store, in a knowledge base associated with the particular topic, the summary as a data representation of the web data;
configure the summary for display via an interactive user interface based on an informative attribute of the text;
generate, for the interactive user interface, an input suggestion associated with the informative attribute to facilitate access to the summary; or
provide, to a user device, a notification that the summary is accessible via the interactive user interface.
